(19) United States
(12) Patent Application Publication
(10) Pub. No.: US 2012/0240008 A1
(43) Pub. Date: Sep. 20, 2012

(54) ENCODER AND STORAGE APPARATUS

(75) Inventors: Haruka OBATA, Tokyo (JP); Hironori Uchikawa, Fujisawa-shi (JP)

(73) Assignee: KABUSHIKI KAISHA TOSHIBA, Tokyo (JP)

(21) Appl. No.: 13/363,667

(22) Filed: Feb. 1, 2012

(30) Foreign Application Priority Data
Mar. 17, 2011 (JP) 2011-059721

(51) Int. Cl. G06F 11/08

(52) U.S. Cl. 714/758; 714/E11.03

(57) ABSTRACT

According to an embodiment, an encoder has a storage and a generator. The storage stores information indicative of a generator matrix corresponding to a partial parity check matrix in a rank-deficient parity check matrix including a lower triangular matrix and one or more cyclic matrices or zero matrices, the partial parity check matrix including rows different from rows of the lower triangular matrix. The generator carries out semi-systematic coding using the generator matrix to generate a portion of code word. The generator matrix has a cyclic matrix portion with one or more cyclic matrices and a non-cyclic matrix portion with rows number of which is equal to a degree of rank deficiency in the partial parity check matrix.

### CROSS-REFERENCE TO RELATED APPLICATIONS

This application is based upon and claims the benefit of priority from prior Japanese Patent Application No. 2011-059721, filed Mar. 17, 2011, the entire contents of which are incorporated herein by reference.

### FIELD

Embodiments relate to error correcting coding.

### BACKGROUND

Much attention has been paid to a technique to utilize a semi-cyclic matrix (or one cyclic matrix), as a parity check matrix because the technique facilitates hardware implementation. The semi-cyclic matrix is obtained by coupling a plurality of cyclic matrices together. Given that the parity check matrix is full rank, diagonalization of a right-hand submatrix of the parity check matrix allows derivation of a generator matrix with a cyclic matrix portion including at least one cyclic matrix.

However, the parity check matrix is not always full rank and may be rank deficient. If the parity check matrix is rank deficient, the right-hand submatrix of the parity check matrix can be partly diagonalized. However, a generator matrix derived simply through diagonalization includes no cyclic matrix portion. Encoding using a generator matrix without a cyclic matrix portion complicates hardware implementation of an encoder and is thus not preferable.

Furthermore, the density (that is, the number) of nonzero elements contained in the generator matrix is desirably low (small). The computational complexity of encoding (that is, the multiplication of a data vector and a generator matrix) in the encoder decreases consistently with the density of nonzero elements.

### BRIEF DESCRIPTION OF THE DRAWINGS

FIG. 1 is a block diagram illustrating a semiconductor memory apparatus including an encoder according to an embodiment;

FIG. 2 is a diagram illustrating a parity check matrix that is a rank-deficient semi-cyclic matrix;

FIG. 3 is a diagram illustrating a matrix derived by diagonalizing a part of a right-hand submatrix of the parity check matrix in FIG. 2;

FIG. 4 is a diagram illustrating a matrix derived from the matrix in FIG. 3;

FIG. 5 is a diagram illustrating a generator matrix derived by applying an elementary row operation to the matrix in FIG. 4;

FIG. 6 is a diagram illustrating a matrix derived by diagonalizing a part of the right-hand submatrix of a parity check matrix corresponding to a semi-cyclic matrix that is rank deficient by 3;

FIG. 7 is a diagram illustrating a matrix derived from the matrix in FIG. 6; and

FIG. 8 is a diagram illustrating a generator matrix derived by applying an elementary row operation to the matrix in FIG. 7.

### DETAILED DESCRIPTION

Embodiments will be described below with reference to the drawings.

According to an embodiment, an encoder has a storage and a generator. The storage stores information indicative of a generator matrix corresponding to a partial parity check matrix in a rank-deficient parity check matrix including a lower triangular matrix and one or more cyclic matrices or zero matrices, the partial parity check matrix including rows different from rows of the lower triangular matrix. The generator carries out semi-systematic coding using the generator matrix to generate a portion of code word. The generator matrix has a cyclic matrix portion with one or more cyclic matrices and a non-cyclic matrix portion with rows number of which is equal to a degree of rank deficiency in the partial parity check matrix.

In the description of the embodiments, for simplification, a symbol is assumed to be a binary code defined on a binary field. That is, in the following description, all nonzero elements that can be covered by a symbol are assumed to be “1”. However, each of the embodiments is applicable to a non-binary code for a symbol defined on a division algebra.

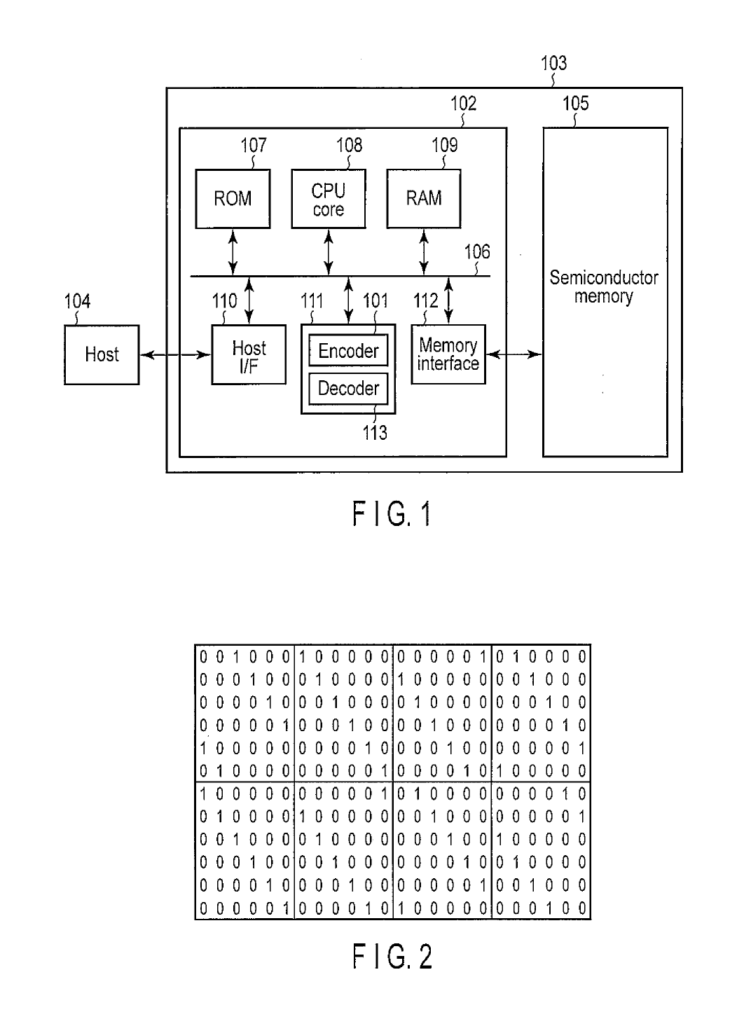

An encoder according to the embodiments is incorporated into, for example, a recording and reproducing system such as a storage apparatus or a communication system such as a transmission apparatus. In general, the encoder according to the embodiments may be incorporated into an apparatus with any configuration which requires error correcting coding. For example, an encoder 101 according to the embodiments may be incorporated into a storage apparatus 103 shown in FIG. 1.

The storage apparatus 103 includes at least one semiconductor memory 105 that is a nonvolatile flash memory such as a flash memory, and a memory controller 102 which controls the semiconductor memory 105. The storage apparatus 103 is connected to a host 104 (for example, a personal computer or a digital camera) to transmit and receive data to and from the host 104. For example, the host 104 can read and write data from and to the storage apparatus 103.

The memory controller 102 includes a read-only memory (ROM) 107, a central processing unit (CPU) core 108, a random access memory (RAM) 109, a host interface 110, an error corrector 111, and a memory interface 112. The elements of the memory controller 102 are connected together by a bus 106.

The CPU core 108 transmits and receives data to and from the host 104 via the host interface 110. The CPU core 108 also transmits and receives data to and from the semiconductor memory 105 via the memory interface 112. That is, the CPU core 108 functions as a reader that receives data from the semiconductor memory 105 or a writer that transmits data to the semiconductor memory 105. Furthermore, firmware executed by the CPU core 108 implements address management for the semiconductor memory 105 including limitation of the number of rewrites. Moreover, the firmware controls the whole storage apparatus 103 in accordance with commands input by the host 104.

ROM 107 stores, for example, a control program for the storage apparatus 103. RAM 109 stores, for example, an address translation table required for the address management and information on an abnormal circuit.

The error corrector 111 includes the encoder 101 and a decoder 113. The encoder according to the embodiments is incorporated into the encoder 101. The encoder 101 adds redundancy bits to data to be written to the semiconductor memory 105. Specifically, as described below, a generator (not shown in the drawings) included in the encoder 101 uses a generator matrix to carry out semi-systematic coding, thus generating a code word. The generator matrix corresponds to a rank-deficient parity check matrix and contains a cyclic matrix portion. Furthermore, typically, the cyclic matrix portion is derived so as to reduce the density of nonzero elements (at least so as to prevent the number of nonzero elements from being maximized). Information indicative of the generator matrix is saved to a storage (not shown in the drawings) included in the encoder 101. Consequently, the encoder 101 allows easy hardware implementation to be adopted and involves low computational complexity for encoding. For example, the encoder 101 can be implemented by using a shift register. On the other hand, the decoder 113 uses the above-described parity check matrix to carry out error correction decoding on data read from the semiconductor memory 105. Since the parity check matrix is a semi-cyclic matrix, the decoder 113 allows easy hardware implementation to be adopted.

### First Embodiment

A generator matrix used by an encoder according to a first embodiment and a technique to derive the generator matrix will be described below. The generator matrix used by the encoder according to the first embodiment is derived based on a parity check matrix corresponding to a semi-cyclic matrix or a cyclic matrix which is not full rank. That is, the parity check matrix contains at least one cyclic matrix and is rank deficient. The generator matrix includes a cyclic matrix portion with at least one cyclic matrix and a non-cyclic matrix portion with rows the number of which is equal to the degree of the rank deficiency in the parity check matrix.

The semi-cyclic matrix means an array of a plurality of b-by-b cyclic matrices or zero matrices. The cyclic matrix means a matrix in which each row vector is obtained by cyclically shifting the elements of a row vector immediately above the row vector of interest, by one element to the right. The zero matrix means a matrix in which all the elements are zero. The b-by-b cyclic matrix or zero matrix is also referred to as a block. In general, a parity check matrix H_{qc} that is a semi-cyclic matrix can be expressed, for example, by:

$${H}_{qc} = [ \begin{matrix}{A}_{1 , 1} & {A}_{1 , 2} & … & {A}_{1 , t} \\ {A}_{2 , 1} & {A}_{2 , 2} & … & {A}_{2 , t} \\ ⋮ & ⋮ & ⋱ & ⋮ \\ {A}_{c , 1} & {A}_{c , 2} & … & {A}_{c , t}\end{matrix} ] \qquad ( 1 )$$

In Expression (1), A_{i, j} denotes one block (i denotes an integer of at least 1 and at most c, and j denotes an integer of at least 1 and at most t). A code word defined by the parity check matrix H_{qc} has a total length equal to t x b symbols, a data length equal to (t−c)×b symbols, and a parity length equal to c×b symbols. Furthermore, the total length, data length, and parity length of the code word may each be converted into a block size b. That is, the code word has a total length of t blocks, a data length of (t−c) blocks, and a parity length of c blocks.

Given that the parity check matrix H_{qc} is full rank, an elementary row operation is used to completely diagonalize a right-hand submatrix (specifically, the (t−c+1)th column to the (t)th column) of the parity check matrix H_{qc}. Then, Expression (2) shown below is obtained. The full rank means that the degree of the rank of a matrix is the same as the number of rows in the matrix. That is, the full rank means that the maximum number of linearly independent row vectors is the same as the number of rows in the matrix. The full rank can be diagonalized.

$${H}_{qc}^{′} = [ \begin{matrix}{A}_{1 , 1}^{′} & {A}_{1 , 2}^{′} & … & {A}_{1 , t - c}^{′} & I & 0 & … & 0 \\ {A}_{2 , 1}^{′} & {A}_{2 , 2}^{′} & … & {A}_{2 , t - c}^{′} & 0 & I & … & 0 \\ ⋮ & ⋮ & ⋱ & ⋮ & ⋮ & ⋮ & ⋱ & ⋮ \\ {A}_{c , 1}^{′} & {A}_{c , 2}^{′} & … & {A}_{c , t - c}^{′} & 0 & 0 & … & I\end{matrix} ] \qquad ( 2 )$$

In the following description, I denotes a unit matrix, and 0 denotes a zero matrix. The elementary row operation for the diagonalization of the right-hand submatrix affects the blocks contained in a left-hand submatrix in Expression (1). Thus, each of the blocks A_{i, j} is transformed into A′_{i, j}. Each of the resultant blocks A′_{i, j} is also a cyclic matrix or a zero matrix. When the left-hand submatrix (specifically, the first column to the (t−c)th column) is expressed by Expression (3) shown below, a generator matrix G based on the parity check matrix H_{qc} can be expressed by Expression (4) also shown below. In the following description, T denotes transposition.

$$\begin{matrix}A = [ \begin{matrix}{A}_{1 , 1}^{′} & {A}_{1 , 2}^{′} & … & {A}_{1 , t - c}^{′} \\ {A}_{2 , 1}^{′} & {A}_{2 , 2}^{′} & … & {A}_{2 , t - c}^{′} \\ ⋮ & ⋮ & ⋱ & ⋮ \\ {A}_{c , 1}^{′} & {A}_{c , 2}^{′} & … & {A}_{c , t - c}^{′}\end{matrix} ] & ( 3 ) \\ G = [ I {A}^{T} ] & ( 4 )\end{matrix}$$

A matrix A is a semi-cyclic matrix. Thus, a transposed matrix A^{T} of the matrix A is also a semi-cyclic matrix. That is, if the parity check matrix Hqc is a semi-cyclic matrix with full rank, the generator matrix G with a cyclic matrix portion (A^{T}) can be derived by coupling the transposed matrix A^{T} of the semi-cyclic matrix A, obtained by diagonalizing the right-hand submatrix of the parity check matrix Hqc, to the right end of the unit matrix I. Encoding using the generator matrix with the cyclic matrix portion can be easily implemented using, for example, a shift register.

A code word (vector) is obtained by multiplying a generator matrix by an information vector with an array of data symbols. A code word resulting from the generator matrix G in Expression (4) retains all the data symbols contained in the information vector intact. The data symbols are followed by an array of a parity symbols. That is, the generator matrix G in Expression (4) implements systematic coding.

On the other hand, if the parity check matrix H_{qc} is a semi-cyclic matrix that is not full rank (that is rank deficient), the right-hand submatrix of the parity check matrix H_{qc} cannot be completely diagonalized. The rank deficiency means that the rank of a matrix is smaller than the number of rows in the matrix. That is, the rank deficiency means that the maximum number of linearly independent row vectors contained in a matrix is smaller than the number of rows in the matrix. If the difference between the number of rows in a matrix and the degree of the rank of the matrix is denoted as X, the matrix is referred to as a matrix that is rank deficient by X.

The parity check matrix H_{qc} shown in FIG. 2 is an example of a semi-cyclic matrix that is rank deficient by 1. The parity check matrix H_{qc} is formed such that two 6-by-6 cyclic matrices are arranged in a row direction, whereas four 6-by-6 cyclic matrices are arranged in a column direction. That is, a code word defined by the parity check matrix H_{qc} in FIG. 2 can be evaluated to have a total length of 4 blocks (that is, (=4×6) symbols), a data length of 2 (=4−2) blocks (that is, 12 (=2×6) symbols), and a parity length of 2 blocks (that is, 12 (=2×6) symbols). However, the real parity length of the parity check matrix H_{qc} is reduced by the degree of rank deficiency. Thus, the real parity length of the code word defined by the parity check matrix H_{qc} in FIG. 2 is 11 (=12−1) symbols. The real data length of the code word is 13 (=24−11) symbols.

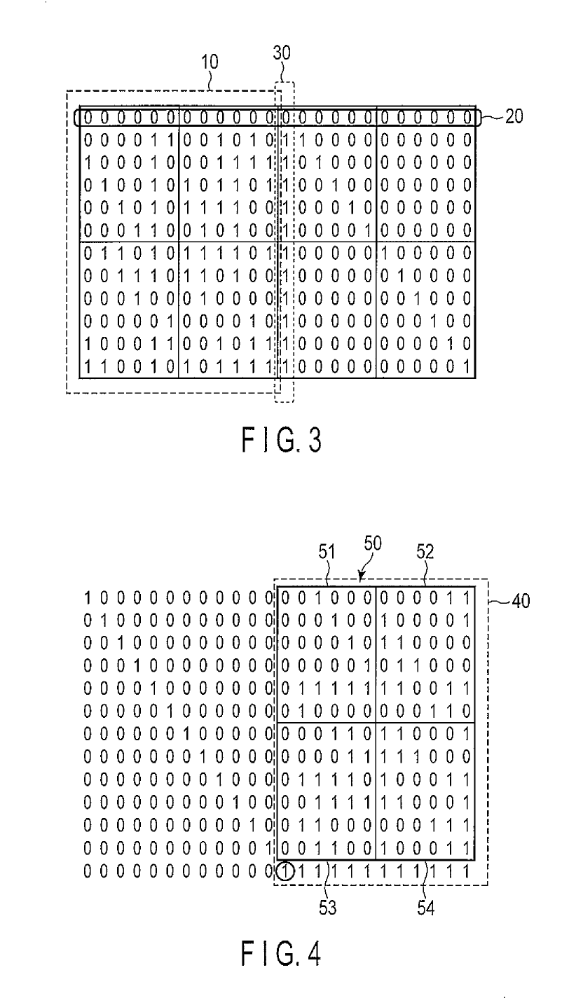

As described above, the right-hand submatrix of the parity check matrix H_{qc} in FIG. 2 cannot completely be diagonalized. However, as shown in FIG. 3, the right-hand submatrix of the parity check matrix H_{qc} in FIG. 2 can be partly diagonalized using an elementary row operation.

The matrix in FIG. 3 contains a row vector 20 corresponding to rank deficiency in the parity check matrix H_{qc} in FIG. 2. In the row vector 20 corresponding to the rank deficiency, an element matching a diagonal component (element in the 1st row and the 13th column) of the right-hand matrix (that is, the 13th row to the 24th row) of the matrix in FIG. 3 is “0”. In the following description, this element is referred to as a target element for convenience. Each of the rows corresponding to the rank deficiency contains only one target element.

According to the technique to derive the generator matrix through diagonalization of the right-hand submatrix of the parity check matrix H_{qc} with full rank as described above, a remaining portion of the diagonalized matrix, that is, the left-hand submatrix (namely, the matrix A in Expression (3) described above), is extracted. Similarly, also in the example illustrated in FIG. 3, a left-hand submatrix 10 (referred to as a matrix B for convenience) is extracted. Moreover, a column vector 30 crossing, at the target element, the row vector 20 corresponding to the rank deficiency is extracted. The target element in the column vector 30 is substituted into “1” to form a vector Q. The vector Q is coupled to the right end of the matrix B. Hence, a 12-by-13 matrix [BQ] is created.

The total number of row vectors corresponding to the rank deficiency is equal to the degree of the rank deficiency in the parity check matrix H_{qc}. That is, the total number of column vectors crossing the row vectors at target elements is also equal to the degree of the rank deficiency in the parity check matrix H_{qc}. Thus, if the degree of the rank deficiency in the parity check matrix H_{qc} is 2 or more, the target elements in the column vectors are substituted into “1”. Then, the resultant column vectors are coupled together in the column direction to form a matrix Q, as described below.

The matrix [BQ] is transposed, and the transposed matrix is coupled to the right end of a unit matrix with a size equal to the number of rows in the matrix B. However, to make the number of rows in the unit matrix equal to the number of rows in the matrix [BQ]^{T}, a zero vector (or a zero matrix) is coupled to the lower end of the unit matrix. The above-described series of operations allow the matrix G expressed by Expression (5) described below to be derived.

$$\begin{matrix}G = [ \begin{matrix}I & {B}^{T} \\ 0 & {Q}^{T}\end{matrix} ] \\ = [ \begin{matrix}{G}^{′} \\ {Q}^{′}\end{matrix} ]\end{matrix} \qquad ( 5 )$$

Application of the operations for the matrix in FIG. 3 allows a matrix shown in FIG. 4 to be derived. In FIG. 4, a matrix 40 corresponds to the matrix [BQ]^{T}, and a matrix 50 corresponds to a matrix B^{T}.

A technique will be described below which allows 2-by-2 blocks 51, 52, 53, and 54 corresponding to the structure of the semi-cyclic matrix in FIG. 2 to be transformed into cyclic matrices. As is apparent from FIG. 4, none of the blocks 51, 52, 53, and 54 is a cyclic matrix.

Specifically, an elementary row operation using zero or more of vector Q′ (or row vectors contained in the matrix Q′) in Expression (5) enables blocks contained in a matrix G′ to be transformed into a cyclic matrix. In the matrix G′, block groups each of at least one block arranged in the same row are formed. In the example illustrated in FIG. 4, a block group of the blocks 51 and 52 and a block group of the blocks 53 and 54 are formed.

An elementary row operation is applied any one row in each of the block groups as a target row. Then, an elementary row operation is applied to all the other rows in the block group so that each block in the block group forms a cyclic matrix containing a sub-vector of the target row subjected to the elementary row operation. In the example illustrated in FIG. 4, an elementary row operation can be applied in which the 13th row is added to the 5th row serving as a target row. An elementary row operation is applied to all the other rows in the block group so that the blocks 51 and 52 form cyclic matrices containing the sub-vectors [100000] and [001100], respectively, of the 5th row subjected to the elementary row operation. Specifically, the 1st, 2nd, 3rd, 4th, and 6th rows are not transformed (that is, an elementary row operation using zero row vector is applied to these rows).

The above-described operations allows the right-hand submatrix of the matrix G′ to be transformed into a semi-cyclic matrix. In Expression (6), each of G_{1, 1}, G_{1, 2}, G_{2, 1}, and G_{2, 2} is a cyclic matrix. A generator matrix G′qc shown in Expression (7) can be derived based on Expressions (5) and (6).

$$\begin{matrix}{G}_{qc} = [ \begin{matrix}I & 0 & {G}_{1 , 1} & {G}_{1 , 2} \\ 0 & I & {G}_{2 , 1} & {G}_{2 , 2}\end{matrix} ] & ( 6 ) \\ {G}_{qc}^{′} = [ \begin{matrix}{G}_{qc} \\ {Q}^{′}\end{matrix} ] & ( 7 )\end{matrix}$$

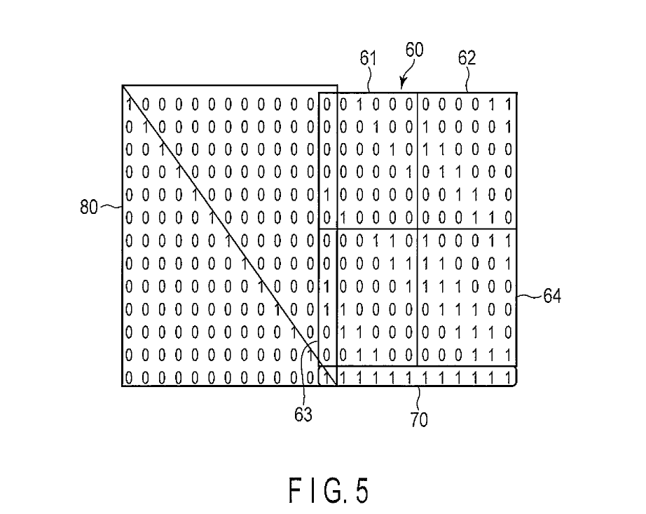

An example of the generator matrix G′_{qc} based on the matrix in FIG. 4 is shown in FIG. 5. In FIG. 5, a matrix 60 represents a cyclic matrix portion. A matrix 70 represents a non-cyclic matrix portion. The cyclic matrix portion 60 contains blocks 61, 62, 63, and 64 corresponding to cyclic matrices into which the above-described blocks 51, 52, 53, and 54 have been transformed. Furthermore, a matrix 80 contains a unit matrix portion. However, the final row (that is, the 13th row) of the matrix 80 is shared with the cyclic matrix portion 60 and the non-cyclic matrix portion 70. Thus, a code word resulting from this generator matrix retains the 1st to 12th data symbols intact, with the 13th data symbol mixed with other data symbol. That is, the generator matrix G′_{qc} in Expression (7) implements semi-systematic coding. In the semi-systematic coding implemented by the generator matrix G′_{qc} in Expression (7), the data symbol the number of which is equal to the degree of the rank deficiency in the parity check matrix is mixed with other data symbol. The encoder according to the present embodiment uses the generator matrix G′_{qc} in Expression (7) to carry out encoding.

Here, the elementary row operation for transforming the blocks 51, 52, 53, and 54 into cyclic matrices is optional. For example, the 5th row may be used as a target row and may avoid being transformed. An elementary row operation is applied to the other rows in the block group so that the blocks 51 and 52 form cyclic matrices containing the sub-vectors [011111] and [110011], respectively, of the 5th row subjected to the elementary row operation. Specifically, the 13th row is added to each of the 1st, 2nd, 3rd, 4th, and 6th rows. These operations also allow the blocks 51 and 52 to be transformed into cyclic matrices.

The number of combinations of elementary row operations applicable to the target row using zero or more of row vectors contained in the non-cyclic matrix Q′ increases consistently with the total number of the row vectors. Given that the total number of the row vectors is n, 2ⁿ combinations of elementary row operations (the number of combinations of elementary row operations corresponds to whether or not each of the n row vectors contained in the non-cyclic matrix portion Q′ are to be added to the target row) are possible.

Thus, the generator matrix G′_{qc} used by the encoder according to the present embodiment is derived so as to reduce the density (number) of nonzero elements contained in the cyclic matrix portion. Specifically, the following of the at least two elementary row operations applicable to the target row are applied: the elementary row operations preventing maximization of the number of nonzero elements contained in the target row subjected to the elementary row operation. In other words, in the derived generator matrix G′_{qc}, at least two elementary row operations using zero or more of the row vectors contained in the non-cyclic matrix portion include at least one elementary row operation that increases the number of nonzero elements when the elementary row operation is applied to any one row contained in the cyclic matrix.

For example, (A) an elementary row operation may be searched for which minimizes the number (that is, the density) of nonzero elements contained in the target row, and the elementary row operation obtained may be applied to the target row. In the generator matrix G′_{qc} derived according to the policy (A), at least two elementary row operations using at least zero of the row vectors contained in the non-cyclic matrix portion do not include any elementary row operation that reduces the number of nonzero elements when the elementary row operation is applied to any one row contained in the cyclic matrix. Alternatively, (B) at least two elementary row operations may be performed on the target row on a trial basis, and an elementary row operation may be selected which prevents the number of nonzero elements from being maximized (which, for example, minimizes the number of nonzero elements) so that the selected elementary row operation can be applied to the target row. Alternatively, (C) the target row may be compared with one or more other rows in the block group in terms of the number of nonzero elements, and one row may be selected which does not have a maximum number of nonzero elements (which, for example, has a minimum number of nonzero elements); this row may be the target row. Moreover, an elementary row operation to be applied to the target row may be searched for so that each of the blocks in the block group forms a cyclic matrix containing a sub-vector of the selected one row.

Deriving the cyclic matrix portion according to any of the various policies enables a reduction in the computational complexity of encoding carried out by the encoder according to the present embodiment.

As described above, the encoder according to the first embodiment carries out semi-systematic coding using a generator matrix corresponding to a rank-deficient parity check matrix and including a cyclic matrix portion. Thus, the encoder according to the present embodiment allows easy hardware implementation to be adopted. Moreover, the encoder according to the present embodiment carries out semi-systematic coding using a generator matrix derived so as to prevent the number of nonzero elements contained in the cyclic matrix portion from being maximized. Consequently, the encoder according to the present embodiment enables the computational complexity of coding to be reduced.

In the description with reference to FIG. 2 to FIG. 5, the parity check matrix H_{qc} that is rank deficient by 1 is illustrated for simplification. However, as described below, a generator matrix can be derived from a parity check matrix H_{qc} that is rank deficient by 2 or more, so as to include a cyclic matrix portion and to prevent the number of nonzero elements contained in the cyclic matrix portion from being maximized.

Here, the parity check matrix H_{qc} is assumed to be a semi-cyclic matrix that is rank deficient by 3 and which is formed such that four 10-by-10 cyclic matrices are arranged in the row direction, whereas five 10-by-10 cyclic matrices are arranged in the column direction. That is, a code word defined by the parity check matrix H_{qc} can be evaluated to have a total length of 5 blocks (that is, 50 (=5×10) symbols), a data length of 1 (=5−4) blocks (that is, 10 (=1×10) symbols), and a parity length of 4 blocks (that is, 40 (=4×10) symbols). However, the real parity length of the code word is reduced by the degree of rank deficiency of the parity check matrix H_{qc}. Thus, the real parity length of the code word defined by the parity check matrix H_{qc} is 37 (=40−3) symbols. The real data length of the code word is 13 (=50−37) symbols.

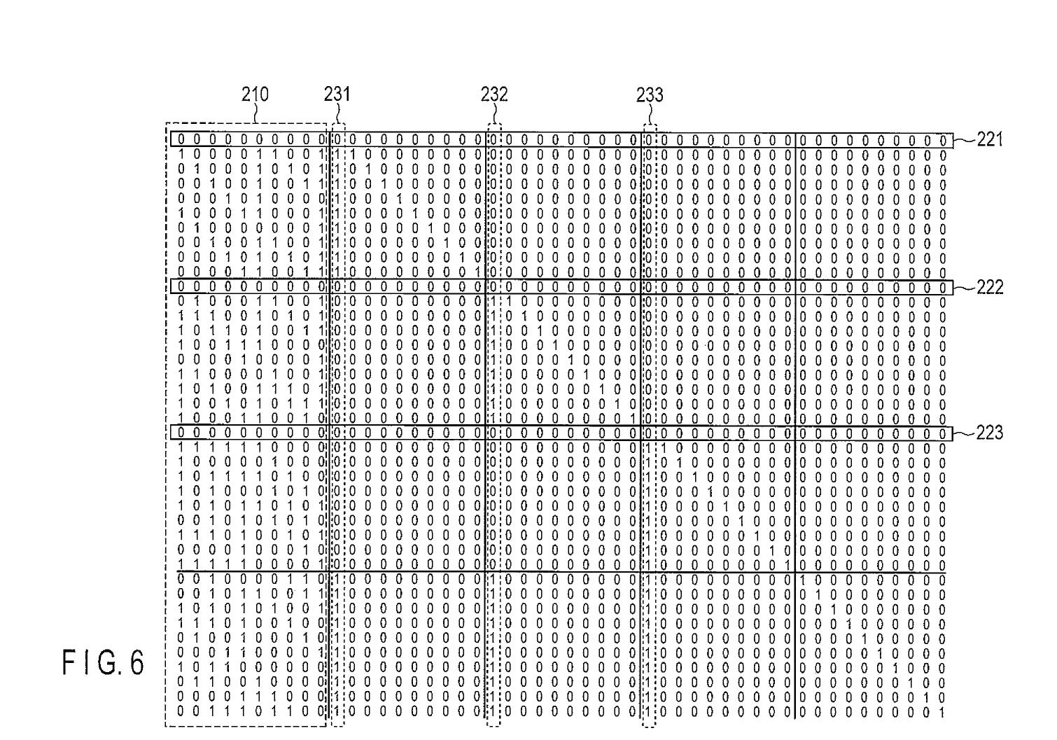

As described above, the right-hand submatrix of the parity check matrix H_{qc} cannot completely be diagonalized. However, as shown in FIG. 6, the right-hand submatrix of the parity check matrix H_{qc} in FIG. 2 can be partly diagonalized using an elementary row operation.

The matrix in FIG. 6 contains row vectors 221, 222, and 223 corresponding to rank deficiency in the parity check matrix H_{qc}. Each of the row vectors 221, 222, and 223 contains one target element.

Also in the example illustrated in FIG. 6, a left-hand submatrix 210 is extracted as the above-described matrix B. Moreover, column vectors 231, 232, and 233 crossing, at target elements, the row vectors 221, 222, and 223 corresponding to the rank deficiency are extracted. The target elements in the column vectors 231, 232, and 233 are substituted into “1”. The resultant column vectors are coupled together in the column direction to form the above-described matrix Q. The matrix Q is coupled to the right end of the matrix B. Hence, a 40-by-13 matrix [BQ] is created.

The matrix [BQ] is transposed, and the transposed matrix is coupled to the right end of a unit matrix with a size equal to the number of rows in the matrix B as in the case of Expression (3). However, to make the number of rows in the unit matrix equal to the number of rows in the matrix {BQ}^{T}, a zero matrix is coupled to the lower end of the unit matrix. The above-described series of operations allow the matrix G expressed by Expression (6) described above to be derived.

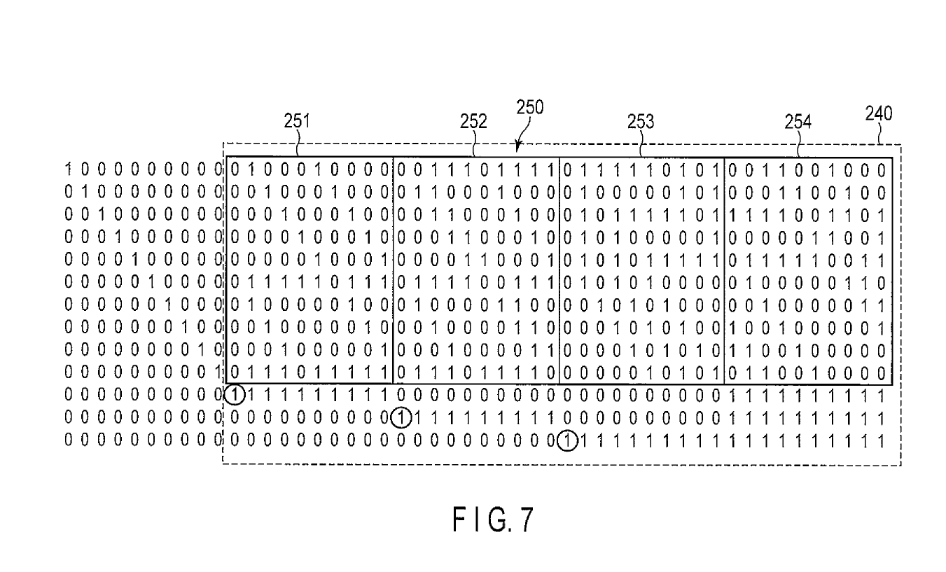

Application of the operations for the matrix in FIG. 6 allows a matrix shown in FIG. 7 to be derived. In FIG. 7, a matrix 240 corresponds to the matrix [BQ]^{T}, and a matrix 250 corresponds to the matrix B^{T}. Each of 1-by-4 blocks 251, 252, 253, and 254 is transformed into a cyclic matrix.

Specifically, as described above, an elementary row operation using zero or more of the row vectors contained in the matrix Q′ in Expression (5) enables blocks contained in the matrix G′ to be transformed into cyclic matrices. In the matrix G′, a block group of at least one block arranged in the same row is formed. In the example illustrated in FIG. 7, a block group of the blocks 251, 252, 253, and 254 is formed.

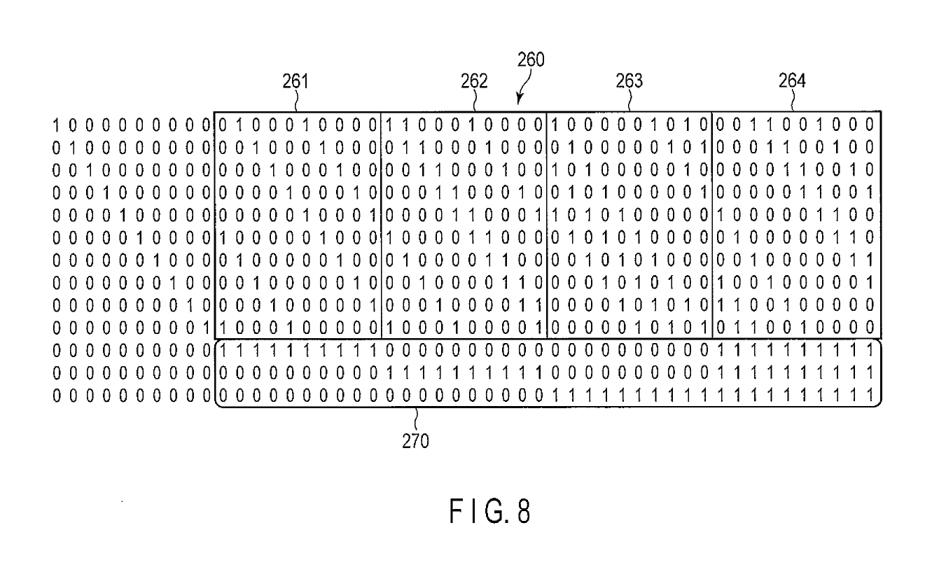

An elementary row operation is applied any one row in the block group as a target row. Then, an elementary row operation is applied to all the other rows in the block group so that each block in the block group forms a cyclic matrix containing a sub-vector of the target row subjected to the elementary row operation. In the example illustrated in FIG. 7, an elementary row operation can be applied in which the 12th and 13th rows are added to the 1st row serving as a target row. An elementary row operation is applied to all the other rows in the block group so that the blocks 251, 252, 253, and 254 form cyclic matrices containing the sub-vectors [0100010000], [1100010000], [1000001010], and [0011001000], respectively, of the 1st row subjected to the elementary row operation. As a result, a generator matrix G′_{qc} shown in FIG. 8 is derived.

In FIG. 8, a matrix 260 represents a cyclic matrix portion. A matrix 270 represents a non-cyclic matrix portion. The cyclic matrix portion 260 contains blocks 261, 262, 263, and 264 corresponding to cyclic matrices into which the above-described blocks 251, 252, 253, and 254 have been transformed. The generator matrix G′_{qc} shown in FIG. 8 also implements semi-systematic coding. That is, a code word resulting from the generator matrix G′_{qc} shown in FIG. 8 retains the 1st to 10th symbols intact. However, the 11th symbol is mixed with other data symbols. The 12th symbol is mixed with other data symbols. The 13th symbol is mixed with other data symbols. The generator matrix G′_{qc} that can be derived from the matrix in FIG. 7 is not limited to that shown in FIG. 8. However, as described above, the generator matrix is derived so as to prevent the number of nonzero elements contained in the cyclic matrix portion from being maximized.

### Second Embodiment

The encoder according to the above-described first embodiment carries out encoding using a generator matrix corresponding to a parity check matrix that is a rank-deficient semi-cyclic matrix. In a second embodiment, the parity check matrix includes a lower triangular matrix portion based on the Richardson and Urbanke (R & U) scheme or the like. For clarity, description of the present embodiment focuses on the R & U scheme. However, the present embodiment is widely applicable to parity check matrices including a lower triangular matrix portion.

The parity check matrix H_{qc} based on the R & U scheme can be expressed by:

$${H}_{qc} = [ \begin{matrix}A & B & T \\ C & D & E\end{matrix} ] \qquad ( 8 )$$

In Expression (8), each of six submatrices A, B, T, C, D, and E includes one or more b-by-b cyclic matrices or zero matrices (that is, blocks). The submatrix A is formed of c2 block rows by d block columns and each of the blocks is a cyclic matrix or a zero matrix. The submatrix B is formed of c2 block rows by c1 block columns and each of the blocks is a cyclic matrix or a zero matrix. The submatrix T is a lower triangular matrix formed of c2 block rows by c2 block columns and each of the blocks is a cyclic matrix or a zero matrix. The lower triangular matrix means a matrix in which all the elements to the right of a diagonal element in each row are zero. Furthermore, in Expression (8), the submatrix C is a matrix formed of c1 block rows by d block columns. The submatrix D is a matrix formed of c1 block rows by c1 block columns. The submatrix E is a matrix formed of c1 block rows by c2 block columns. A code word defined by the parity check matrix H_{qc} in Expression (8) has a total length of b×(d+c1+c2) symbols, a data length of b×d symbols, and a party length of b×(c1+c2) symbols.

The submatrix T is a lower triangular matrix and thus its inverse matrix T⁻¹ exists. Thus, the submatrix E can be transformed into a zero matrix by multiplying the parity check matrix H_{qc} by an appropriate matrix from the left end of the parity check matrix H_{qc}, as indicated by Expression (9) shown below. In the following description, matrices with “−1” added to the upper right thereof correspond to the respective inverse matrices of the original matrices.

$$\begin{matrix}{H}_{qc}^{′} = [ \begin{matrix}I & 0 \\ - {ET}^{- 1} & I\end{matrix} ] [ \begin{matrix}A & B & T \\ C & D & E\end{matrix} ] \\ = [ \begin{matrix}A & B & T \\ - {ET}^{- 1} A + C & - {ET}^{- 1} B + D & 0\end{matrix} ]\end{matrix} \qquad ( 9 )$$

For a code word vector w defined by the parity check matrix H′_{qc} in Expression (9), H′_{qc}w^{T}=0 holds true. In the code word vector w, a sub-vector having b×d data symbols is denoted by m. The succeeding sub-vector comprising b×c1 parity symbols is denoted by p₁. The succeeding sub-vector including b×c2 parity symbols is denoted by p₂. Then, w=[mp₁p₂]. According to Expression (9) and the definition of the code word vector w, Expression (10) shown below holds true for the sub-vector p₁. Furthermore, Expression (11) also shown below holds true for the sub-vector p₂. Additionally, φ in Expression (10) is defined by Expression (12) also shown below.

p₁^{T}=−φ⁻¹(−ET⁻¹A+C)ₘ^{T} (10)

p₂^{T}=−T⁻¹(Am^{T}+Bp₁^{T}) (11)

φ=−ET⁻¹B+D (12)

Expression (10) includes the inverse matrix φ⁻¹ of the matrix φ. However, in the present embodiment, the parity check matrix H_{qc} is rank deficient. Thus, the inverse matrix φ⁻¹ of the matrix p does not exist. Hence, with reference to Expression (9), a partial parity check matrix H_{qc}^{p1} for the sub-vector p₁ is defined by:

H_{qc}^{p1}=[−ET⁻¹A+C−ET⁻¹B+D] (13)

The partial parity check matrix H_{qc}^{p1} in Expression (13) is similar to the parity check matrix H_{qc} in Expression (1) described above in that both the matrices are rank-deficient (semi) cyclic matrices. Thus, a partial generator matrix corresponding to the partial parity check matrix H_{qc}^{p1} can be derived by application of a technique similar to that according to the above-described first embodiment, with the partial parity check matrix H_{qc}^{p1} considered to be the parity check matrix H_{qc} in Expression (1). The partial parity check matrix is derived so as to include a cyclic matrix portion and to prevent the number of nonzero elements contained in the cyclic matrix portion from being maximized, as is the case with the generator matrix used by the encoder according to the first embodiment.

On the other hand, according to Expression (11) described above, the sub-vector p₂ can be derived from the sub-vectors m and p₁. If the parity check matrix H_{qc} defines an LDPC code or the like, each of the submatrices A and B has a very low density and thus requires only a small amount of calculation to derive the sub-vector p₂. This enables a reduction in the computational complexity of the encoder. Furthermore, the inverse matrix T⁻¹ of the submatrix T, which is a lower triangular matrix, exists as described above.

As described above, the encoder according to the second embodiment carries out semi-systematic coding using a partial generator matrix including a cyclic matrix portion and corresponding to a partial parity check matrix for a partial parity included in a rank-deficient parity check matrix based on the R & U scheme. Thus, the encoder according to the present embodiment allows easy hardware implementation to be adopted. Moreover the encoder according to the second embodiment carries out semi-systematic coding using a partial generator matrix derived so as to prevent the number of nonzero elements contained in the cyclic matrix portion. Therefore, the encoder according to the present embodiment enables a reduction in the computational complexity of encoding.

The processing of each of the above-described embodiments can be realized using a general-purpose computer as a basic hard ware. It is possible to provide a program that realizes the processing of each of the above-described embodiments by storing the program in a computer-readable storage medium. Such a program is stored in a storage medium in a file of installable form, or a file of executable form. A storage medium may be a magnetic disk, an optical disc (such as CD-ROM, CD-R, DVD, etc.), a magneto-optical disc (MO, etc.) or a semiconductor memory, as long as it can store a program and is computer-readable. Also, the program that realizes the processing of each of the above-described embodiments may be stored on a computer (server) connected to network such as the Internet and may be downloaded by a computer (client) via network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An encoder comprising:
a storage which stores information indicative of a generator matrix corresponding to a partial parity check matrix in a rank-deficient parity check matrix comprising a lower triangular matrix and one or more cyclic matrices or zero matrices, the partial parity check matrix comprising rows different from rows of the lower triangular matrix; and
a generator which carries out semi-systematic coding using the generator matrix to generate a portion of code word,
wherein the generator matrix comprises a cyclic matrix portion with one or more cyclic matrices and a non-cyclic matrix portion with rows number of which is equal to a degree of rank deficiency in the partial parity check matrix.

2. The encoder according to claim 1, wherein at least one elementary row operation using at least one row vector contained in the non-cyclic matrix portion include an elementary row operation which increases number of nonzero elements if the elementary row operation is applied to any one row contained in the cyclic matrix portion.

3. The encoder according to claim 2, wherein at least one elementary row operation using at least one row vector contained in the non-cyclic matrix portion do not include any elementary row operation which decreases number of nonzero elements if the elementary row operation is applied to any one row contained in the cyclic matrix portion.

4. A storage apparatus comprising:
a semiconductor memory; and
a controller which comprises:
the encoder according to claim 1; and
a writer which sends the code word to the semiconductor memory.

5. An encoder comprising:
a storage which stores information indicative of a generator matrix corresponding to a rank-deficient parity check matrix comprising one or more cyclic matrices or zero matrices; and
a generator which carries out semi-systematic coding using the generator matrix to generate a code word, and
wherein the generator matrix includes a cyclic matrix portion with one or more cyclic matrices and a non-cyclic matrix portion with rows number of which is equal to a degree of rank deficiency in the parity check matrix, and
at least one elementary row operation using at least one row vector contained in the non-cyclic matrix portion include an elementary row operation which increases number of nonzero elements if the elementary row operation is applied to any one row contained in the cyclic matrix portion.

6. The encoder according to claim 5, wherein at least one elementary row operation using at least one row vector contained in the non-cyclic matrix portion do not include any elementary row operation which decreases number of nonzero elements if the elementary row operation is applied to any one row contained in the cyclic matrix portion.
